(19) United States
(12) Patent Application Publication
(10) Pub. No.: US 2013/0198775 A1
(43) Pub. Date: Aug. 1, 2013

(54) APPARATUS, METHOD AND SYSTEM FOR PROVIDING ADDITIONAL INFORMATION THROUGH DIGITAL MEDIA CONTENT

(71) Applicant: Electronics and Telecommunications Research Institute, Daejon (KR)

(72) Inventors: Eun Hee HYUN, Daejeon-si (KR); Kyeong Soo HAN, Daejeon-si (KR)

(73) Assignee: Electronics and Telecommunications Research Institute, Daejeon (KR)

(21) Appl. No.: 13/719,181

(22) Filed: Dec. 18, 2012

(30) Foreign Application Priority Data
Jan. 31, 2012 (KR) 10-2012-0010041

(51) Int. Cl. H04N 21/435

(52) U.S. Cl. CPC H04N 21/435
USPC 725/34

(57) ABSTRACT

A method, an apparatus, and a system for providing additional information through a digital media content are provided. The method includes: detecting an item selected by a user selection when the user selection is sensed in a media content that is being reproduced; judging whether the user selection is a first selection for primarily selecting the item or a second selection for secondarily selecting the item in a set time after the item is primarily selected; and highlighting at least a portion of the item according to a set display format according to whether or not additional information linked to the item is present in the case in which the user selection is the first selection and displaying the additional information linked to the item in the case in which the user selection is the second selection.

### CROSS-REFERENCE TO RELATED APPLICATIONS

This application claims the benefit of priority of Korean Patent Application No. 10-2012-0010041 filed on Jan. 31, 2012, all of which are incorporated by reference in their entirety herein.

### BACKGROUND OF THE INVENTION

1. Field of the invention

The present invention relates to a system and a method for providing additional information through a digital media content, and more particularly, to a technology for providing additional information capable of efficiently providing additional information such as an advertisement, or the like, without hindering the viewing of a broadcasting content by linking the additional information such as the advertisement, or the like, to items included in a media content reproduced in a user terminal and allowing the additional information to be exposed according to an intentional selection of a user.

2. Related Art

Recently, in accordance with the progress of a interactive broadcasting service in a digital broadcasting environment, it is expected that a service environment in which a viewer may designate and view a desired broadcasting content in a desired time, such as a video on demand (VOD) service, or the like, beyond a one sided push type broadcasting service will be increased.

This change in an active broadcasting viewing form of consumers in a interactive broadcasting service environment may be used in order to increase an effect of an advertisement in a broadcasting advertisement region as well as the viewing of the broadcasting content. Actually, an example of the development of a related technology and service has increased.

In a interactive advertisement which goes beyond an existing type advertisement performed before and after the consumers view the broadcasting content, advertisement opportunities capable of informing viewers of products or services are inserted in various types into a broadcasting content exposed to the viewers to induce participation of the consumers, thereby making it possible to improve an effect of the advertisement based on mutual communication.

Particularly, it is expected that a content based advertisement service linking the interest of users in a background, a place, a material, photographing props, fashion of actors, and the like, configuring a program to an advertisement for the related product or service during the viewing of the broadcasting content will improve the effect of the advertisement. To this end, studies on methods of inserting an advertisement in a broadcasting content have been conducted.

In addition to the insertion of the advertisement into the broadcasting content, technologies of allowing a viewer to simultaneously view a linked advertisement for another product or service that is linked or closely related to a corresponding advertisement in an advertisement content during the viewing of the advertisement and then allowing a screen to move to an additional advertisement by an selection of the viewer have been suggested.

Korean Patent Laid-Open Publication No. 2004-0081875 has disclosed a screen advertisement method using a television broadcasting network that is to allow a displayed advertisement not to hinder the viewing of broadcasting simultaneously with increasing concentration on the displayed advertisement by transparently overlapping and displaying advertisement information related to a broadcasting content displayed on a screen at one side of the screen.

In the case of the related art as described above, the advertisement is overlapped on the screen of the broadcasting content to allow the viewing not to be hindered.

Nevertheless, in the advertisement scheme according to the related art, a phenomenon that a portion of the screen is inevitably is taken away as a region for displaying the advertisement is generated or a portion of an image of the broadcasting content may be blinded to hinder the viewer from viewing the broadcasting content.

Furthermore, in the advertisement scheme according to the related art, in the case in which targets of advertisements that is to be inserted into the broadcasting content are too much, all of the advertisements may not be inserted. In addition, the advertisement is displayed one-sidedly regardless of the individual intention of the viewer, the viewer that is not interested in the advertisement content can not but feel discomfort.

Therefore, the development of a technology capable of efficiently an advertisement linked to a broadcasting content without having an effect on viewing of the broadcasting content as much as possible has been urgently demanded.

### RELATED ART DOCUMENT

### Patent Document

Korean Patent Laid-Open Publication No. 2004-0081875

### SUMMARY OF THE INVENTION

The present invention provides a method, an apparatus, and a system for providing additional information through a digital media content capable of efficiently displaying additional information linked to a media content without having an effect on viewing of the media content as much as possible by highlighting an item displayed on the media content at the time of a primary selection of the item by a user and displaying the item at the time of a secondary selection of the item.

In an aspect, a method for providing additional information through a digital media content is provided. The method uses an apparatus for providing additional information included in a user terminal and includes: detecting an item selected by a user selection when the user selection is sensed in a media content that is being reproduced; judging whether the user selection is a first selection for primarily selecting the item or a second selection for secondarily selecting the item in a set time after the item is primarily selected; and highlighting at least a portion of the item according to a set display format according to whether or not additional information linked to the item is present in the case in which the user selection is the first selection and displaying the additional information linked to the item in the case in which the user selection is the second selection.

The method may further include: pausing the media content that is being reproduced based on the sensing of the user selection; and reproducing the paused media content from a point in time at which the media content is paused in the case in which the second selection is not sensed for the set time after the first selection or the displaying of the additional information linked to the item ends.

The additional information may be an advertisement linked to the item and include information for reproducing an advertisement content or moving to a linked web page.

The highlighting of at least a portion of the item according to the set display format may include highlighting any one of at least a portion of an edge portion of the item or the entire item.

The displaying may include: judging whether the additional information linked to the item is present based on metadata of the media content in the case in which the user selection is the first selection; and highlighting at least a portion of the item in the case in which the additional information linked to the item is present.

In another aspect, an apparatus for providing additional information is provided. The apparatus is included in a user terminal and includes: a selection item detecting unit detecting an item selected by a user selection when the user selection is sensed in a media content that is being reproduced; a selection judging unit judging whether the user selection is a first selection for primarily selecting the item or a second selection for secondarily selecting the item in a set time after the item is primarily selected; and an information displaying unit highlighting at least a portion of the item according to a set display format according to whether or not additional information linked to the item is present in the case in which the user selection is the first selection and displaying the additional information linked to the item in the case in which the user selection is the second selection.

The information displaying unit may pause the media content that is being reproduced based on the sensing of the user selection and reproduce the paused media content from a point in time at which the media content is paused in the case in which the second selection is not sensed for the set time after the first selection or the displaying of the additional information linked to the item ends. The additional information may be an advertisement linked to the item and include information for reproducing an advertisement content or moving to a linked web page. The information displaying unit may highlight any one of at least a portion of an edge portion of the item or the entire item.

The information displaying unit may judge whether the additional information linked to the item is present based on metadata of the media content in the case in which the user selection is the first selection and highlight at least a portion of the item in the case in which the additional information linked to the item is present.

In still another aspect, a method for providing additional information is provided. The method includes: judging whether or not additional information linked to an item displayed in a media content that is being reproduced is present based on metadata of the media content in response to a first selection for primarily selecting the item; highlighting at least a portion of the item according to a set display format according to whether or not the additional information linked to the item is present; and displaying the additional information linked to the item in response to a second selection for secondarily selecting the item.

The method may further include: pausing the media content that is being reproduced in the case in which the additional information linked to the item is present; and reproducing the paused media content from a point in time at which the media content is paused in the case in which the displaying of the additional information linked to the item ends.

In still another aspect, a system for providing additional information is provided. The system includes: a server unit inserting additional information linked to an item included in a media content and a highlighting scheme to be applied to the item into metadata of the media content and transmitting the metadata; and a terminal unit judging whether or not the additional information linked to the item is present based on the metadata received from the server unit in response to a first selection of a user for primarily selecting the item at the time of reproduction of the media content, highlighting at least a portion of the item according to a set display format according to whether or not the additional information linked to the item is present, and displaying the additional information linked to the item in response to a second selection of the user for secondarily selecting the item.

The terminal unit may pause the media content that is being reproduced in the case in which the additional information linked to the item is present and reproduce the paused media content from a point in time at which the media content is paused in the case in which the displaying of the additional information linked to the item ends. The terminal unit may highlight any one of at least a portion of an edge portion of the item or the entire item.

The server unit may interwork with an advertiser system, insert information indicating that the additional information is linked to the item requested by the advertiser system in the media content into the metadata, and designate the highlighting scheme of the metadata to insert the designated highlighting scheme into the metadata.

### BRIEF DESCRIPTION OF THE DRAWINGS

FIG. 1 is a block diagram showing a configuration of a system for implementing a method for providing additional information through a digital media content according to an exemplary embodiment of the present invention.

FIG. 2 is a block diagram describing a detailed configuration of an additional information providing terminal unit included in a user terminal.

FIG. 3 is a flow chart describing the method for providing additional information according to the exemplary embodiment of the present invention.

FIG. 4 is a diagram showing an example of highlighting an item by the additional information providing terminal unit, that is, a case in which a user is interested in a product appearing in a media content.

FIG. 5 is a diagram showing another example of highlighting an item by the additional information providing terminal unit, that is, a case in which a user is interested in a place at which a digital media content is photographed.

FIG. 6 is a block diagram describing a detailed configuration of an additional information providing server unit.

FIG. 7 is a flow chart describing a procedure of using a service in a system environment to which the method for providing additional information according to the exemplary embodiment of the present invention is applied.

### DESCRIPTION OF EXEMPLARY EMBODIMENTS

Since the present invention may be variously modified and have several exemplary embodiments, specific exemplary embodiments will be shown in the to accompanying drawings and be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component and the ‘second’ component may also be similarly named the ‘first’ component, without departing from the scope of the present invention. A term ‘and/or’ includes a combination of a plurality of related described items or any one of the plurality of related described items.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

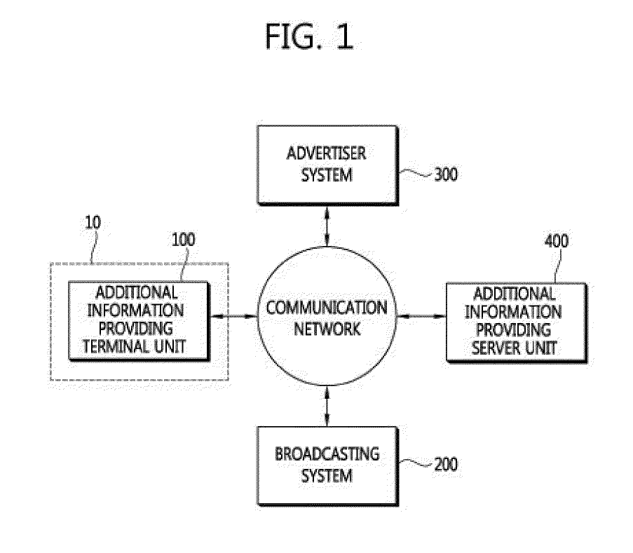

FIG. 1 is a block diagram showing a configuration of a system for implementing a method for providing additional information through a digital media content according to an exemplary embodiment of the present invention.

As shown in FIG. 1, the system may include an additional information providing terminal unit 100 and an additional information providing server unit 400 that may interwork with each other through a communication network. The additional information providing terminal unit 100 or the additional information providing server unit 400 may interwork with a broadcasting system 200 and an advertiser system 300 through the communication network.

The additional information providing terminal unit 100 may be included in a user terminal 10. The user terminal 10 may be a fixed type network terminal such as a television set, a set top box, a personal computer, or the like, or a portable terminal such as a smart phone, a personal digital assistance, a laptop computer, or the like. The user terminal 10 may receive and reproduce a media content such as a broadcasting program, a video on demand (VOD) content, or the like, provided from the broadcasting system 200 through the communication network. The user terminal 10 may also reproduce a media content stored in a compact disk, a hard disk, a universal serial bus (USB) storage device, or the like.

The user terminal 10 may include a display device for displaying a reproduced content on a screen, an input device for inputting a request of a user, and the like. For example, the user terminal 10 may include a display panel such as a liquid crystal display (LCD), a plasma display panel (PDP), an organic light emitting diode (OLED), or the like, and an input device such as a remote controller, a keyboard, a mouse, or the like. Alternatively, the user terminal 10 may include a touch screen in a form in which the display device and the input device are integrated with each other.

The additional information providing terminal unit 100 may be included in the user terminal 10 to highlight an item to which additional information such as an advertisement is linked among items displayed on the screen at the time of reproduction of the media content according to a selection of the user, thereby informing the user of the item to which the additional information is linked and providing the additional information linked to the item in the case of being desired by the user. Hereinafter, a function of the additional information providing terminal unit 100 will be described in detail.

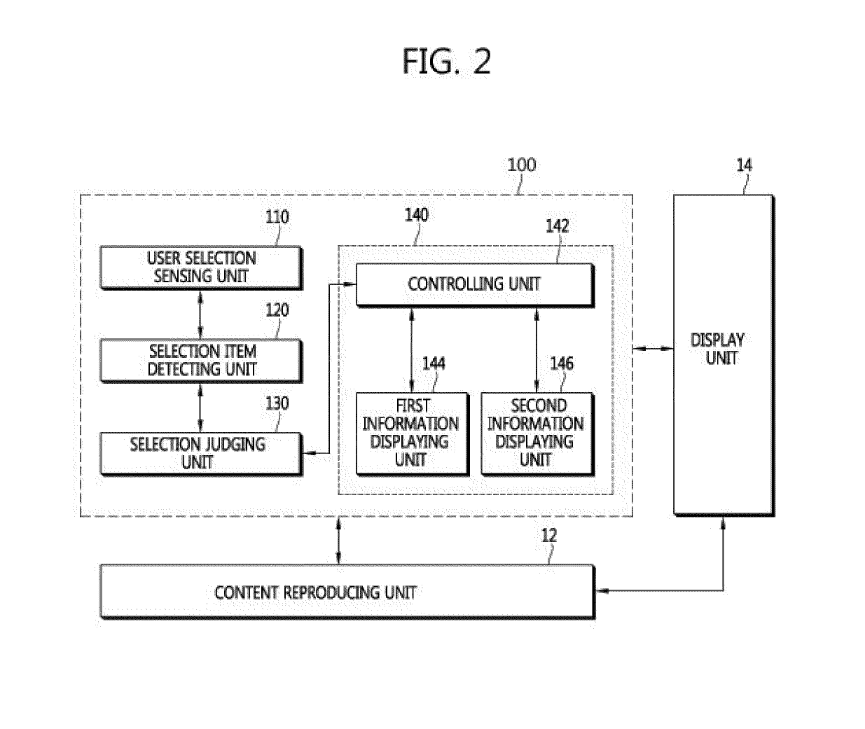

FIG. 2 is a block diagram describing a detailed configuration of an additional information providing terminal unit 100 included in a user terminal 10.

As shown in FIG. 2, the additional information providing terminal unit 100 may include a user selection sensing unit 110, a selection item detecting unit 120, a selection judging unit 130, an information displaying unit 140, and the like. The additional information providing terminal unit 100 may interwork with a content reproducing unit 12 and a display unit 14 of the user terminal 10.

The content reproducing unit 12 of the user terminal 10 may serve to reproduce a media content. The media content may be a broadcasting content received through a digital broadcasting network or a VOD content transmitted from a VOD server. Alternatively, the media content may be a media content stored in the user terminal 10 or stored in a medium connected to the user terminal, for example, a CD or a USB storage device. According to the present embodiment, it will be assumed that the media content is a broadcasting content transmitted from the broadcasting system 200. However, this is only an example and the present invention is not limited thereto.

The media content reproduced by the content reproducing unit 12 may be displayed on a screen provided by the display unit 14 of the user terminal 10. Therefore, the user may view the media content reproduced by the content reproducing unit 12, for example a broadcasting program, a movie, a music video, or the like, through the screen of the display unit 14.

At the time of the reproduction of the media content, various items such as clothing, electric home appliances, a cap, an accessory, a food, a building, a hospital, shoes, a topographic feature, and the like, appear on the screen of the display unit 14. The user may select an interested item in order to purchase the interested item or obtain additional information among the various items. For example, in the case in which the media content is displayed through the touch screen, the user may select a desired item by touch the desired item on a screen of the touch screen. Alternatively, the user may also select an item displayed on the screen using various input devices such as a remote controller, a mouse, a keyboard, and the like.

The user selection sensing unit 110 may serve to sense a user selection indicating that a specific item was selected when the user selects the specific item in the media content at the time of the reproduction of the media content. For example, the user selection sensing unit 110 may sense a touch screen input signal, a remote controller input signal, or the like, selecting a desired item when the user selects the desired item on a reproduction screen of the media content using the touch screen, the remote controller, or the like.

The selection item detecting unit 120 may serve to detect the item selected by the user selection sensed by the user selection sensing unit 100. For example, when it is assumed that a home appliance is selected among a plurality of items displayed on the screen at the time of the reproduction of the media content, the user item detecting unit 120 may detect that the home appliance was selected.

The selection judging unit 130 may judge whether the user selection is a first selection for primarily selecting the item or a second selection for secondarily selecting the item performed in a set time after primarily selecting the item.

The first selection may be a primary selection for confirming whether the additional information is present in the item in the media content. For example, the user may primarily select an item displayed on the screen at the time of the reproduction of the media content in order to confirm whether the additional information is present in the item. The second selection may be a secondary selection for confirming the additional information such as the advertisement, or the like, related to the item after the primary selection. For example, the user may secondarily select the item in order to confirm the additional information of the item confirmed that the additional information was present.

In addition, the selection judging unit 130 may transfer a message including item identification information and information on a selection judging result to the information displaying unit 140. For example, the selection judging unit 130 may an information message including identification information capable of identifying the item selected by the user selection and user selection judging information indicating whether the user selection is the first selection or the second selection to the information displaying unit 140.

The information displaying unit 140 may highlight at least a portion of the item according to a set display format according to whether or not the additional information linked to the item is present in the case in which the user selection is the first selection and display the additional information linked to the item in the case in which the user selection is the second selection, based on the information message transferred from the selection judging unit 130.

For example, the information displaying unit 140 may confirm the user selection judging information included in the information message transferred from the selection judging unit 130, judges whether the additional information is present in the item corresponding to the item identification information in the case in which it is confirmed that the user selection is the first selection, and pauses the content that is being reproduced and then highlight at least a portion of the item displayed on the screen in the case in which it is judged that the additional information is present.

On the other hand, in the case in which the selection judging result indicates that the user selection is the second selection, the information displaying unit 140 may display the additional information linked to the item. Meanwhile, in the case in which the second selection is not sensed for a set time after the highlighting or the displaying of the additional information linked to the item ends, the information displaying unit 140 may also reproduce the paused media content from a point in time at which the media content is paused.

In order to perform the above-mentioned process, the information displaying unit 140 may use information included in metadata of the media content. The metadata of the media content may include the additional information linked to the item, information related to the additional information, a highlighting scheme to be applied to the item, and the like. The metadata of the digital content may be generated by the additional information providing server unit 400. The metadata may be transmitted to and stored in the user terminal 10, together with the media content, or may be transmitted to and stored in the user terminal 10, through a path separate from the media content.

The information displaying unit 140 may include a controlling unit 142, a first information displaying unit 144, and a second information displaying unit 146.

The controlling unit 142 may transmit an indication message to the first information displaying unit 144 and the second information displaying unit 146 and control the pause and the reproduction of the media content, based on the metadata of the media content and the information message transferred from the selection judging unit 130. The first information displaying unit 144 may highlight at least a portion of the item on the screen designated according to an indication message of the controlling unit. The second information displaying unit 146 may display the additional information such as the advertisement, or the like, linked to the item designated according to the indication message of the controlling unit 142 on the screen of the displaying unit 14.

For example, the controlling unit 142 may confirm the item identification information and the user selection judging information included in the information message transferred from the selection judging unit 130 and search the metadata of the media content to judge whether the additional information is present in the item corresponding to the item identification information in the case in which the user selection is the first selection.

In the case in which the additional information is present, the controlling unit 142 may pause the content that is being reproduced and then transmit an indication message indicating that the first information displaying unit 144 highlights at least a portion of the item to the first information displaying unit 144. The indication message may include the item identification information and information related to a highlighting scheme. In this case, the first information displaying unit 144 highlights at least a portion of the item.

As the highlighting scheme for highlighting at least a portion of the item, various schemes such as a scheme of highlighting an edge portion of the item or a portion of the edge portion so as to be distinguished from other portions using a method of allowing the edge portion or a portion of the edge portion to be viewed as a set color or seem to be protruded or be depressed, a scheme of highlighting the entire item so as to be distinguished from other portions using a method of allowing the entire item to be viewed as a set color or seem to be protruded or be depressed, and the like, may be used.

The highlighting scheme and the highlighted item may be set by being included in the metadata of the media content transferred from the additional information providing server unit 400 to thereby be transferred to the additional information providing terminal unit 100, as described above, or be preset in the additional information providing terminal unit 100.

Meanwhile, in the case in which the secondary selection is not performed for a set time after the item is highlighted, the controlling unit 142 may reproduce the paused media content from a point in time at which the media content is paused or output a confirmation message informing that the reproduction of the paused media content will restart and then reproduce the paused media content at the point in time from which the media content is paused according to a request of the user.

Meanwhile, in the case in which the user selection is the second selection for secondarily selecting the item, that is, the selection for selecting the highlighted item, the controlling unit 142 may transmit an indication message indicating that the second information displaying unit displays the additional information linked to the item to the second information displaying unit 146. The second information displaying unit 146 may display the additional information on the screen of the display unit 14 according to the indication message transmitted from the controlling unit 142.

The indication message may include the item identification information, the additional information of the item, and information capable of accessing the additional information. The additional information may include information for reproducing a content related to the item, for example, an advertisement content, or the like, and link information for moving to a web page related to the item, a shopping mall page selling the corresponding item, an information providing page providing information related to the item, or the like.

Meanwhile, when the display of the additional information ends, the controlling unit 142 may reproduce the media content paused at the time of the first selection from a point in time at which the media content is paused or output a confirmation message informing that the reproduction of the paused media content will restart and then reproduce the media content from the point in time at which the media content is paused according to a request of the user. In addition, the controlling unit 142 may also display a message inducing the item to be secondarily selected.

Hereinabove, the configuration of the additional information providing terminal unit included in the user terminal has been described. Hereinafter, a method for providing additional information based on the additional information providing terminal unit will be described.

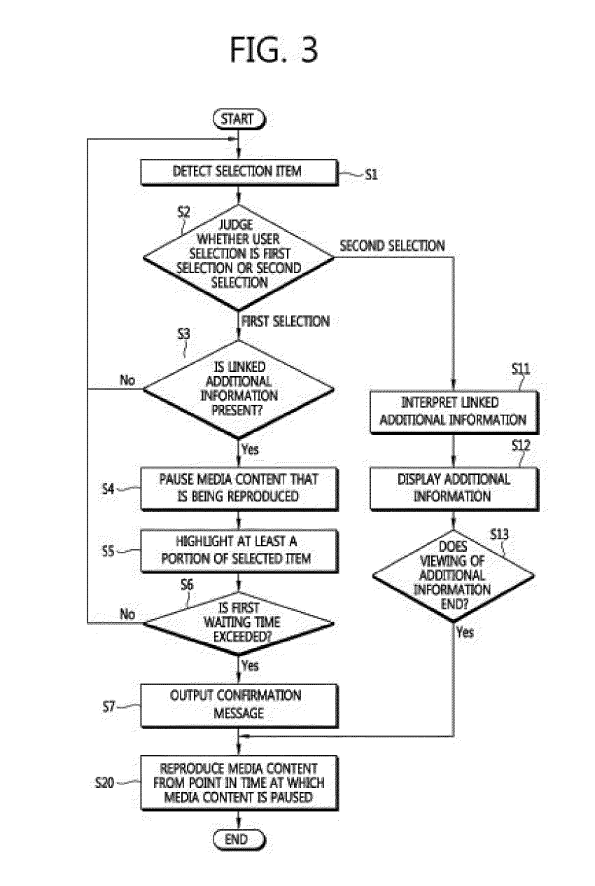

FIG. 3 is a flow chart describing the method for providing additional information according to the exemplary embodiment of the present invention.

As shown in FIG. 3, in the case in which a specific item is selected in a media content by the user when the media content is reproduced, the additional information providing terminal unit 100 senses a user selection and detects an item selected by the sensed user selection (S1). For example, in the case in which the user selects a desired item on a reproduction screen of the media content using a touch screen, a remote controller, or the like, the additional information providing terminal unit may sense a touch screen input signal, a remote controller input signal, or the like, selecting the item and then detect which item was selected by the user.

Next, the additional information providing terminal unit 100 may judge whether the user selection is a first selection for primarily selecting the item or a second selection for secondarily selecting the item performed in a set time after primarily selecting the item (S2). That is, the additional information providing terminal unit 100 judges whether the user selects the item in order to confirm whether additional information is present in the item or in order to view the additional information.

In the case in which the user selection is the first selection, the additional information providing terminal 100 may judge whether or not the additional information linked to the item is present using metadata of a digital content (S3). In the case in which the additional information is present, the additional information providing terminal unit 100 may pause the media content that is being reproduced (S4) and highlight at least a portion of the selected item (S5).

Here, as a highlighting scheme, a scheme designated in the metadata of the media content may be used. As the highlighting scheme, at least one of various schemes such as a scheme of highlighting an edge portion of the item so as to be distinguished from other portions using a method of allowing the edge portion to be viewed as a set color or seem to be protruded or be depressed, a scheme of highlighting the entire item so as to be distinguished from other portions using a method of allowing the entire item to be viewed as a set color or seem to be protruded or be depressed, and the like, may be used.

Meanwhile, whether or not the user selection is performed on the item until a set time elapses after the item is highlighted is judged (S6). When the user selection is sensed, this selection may be the second selection for secondarily selecting the item. When the user selection is not sensed, the additional information providing terminal unit 100 outputs a confirmation message (S7) and reproduces the media content from a time in point at which the media content is paused (S20).

In the case in which the user selection is the second selection, the additional information providing terminal unit 100 may interpret the linked to the additional information (S11) and then display the additional information. Therefore, the user may view the additional information linked to the item. When the displaying of the additional information ends (S13), the additional information providing terminal unit 100 may reproduce the media content from the point in time at which the media content is paused (S20).

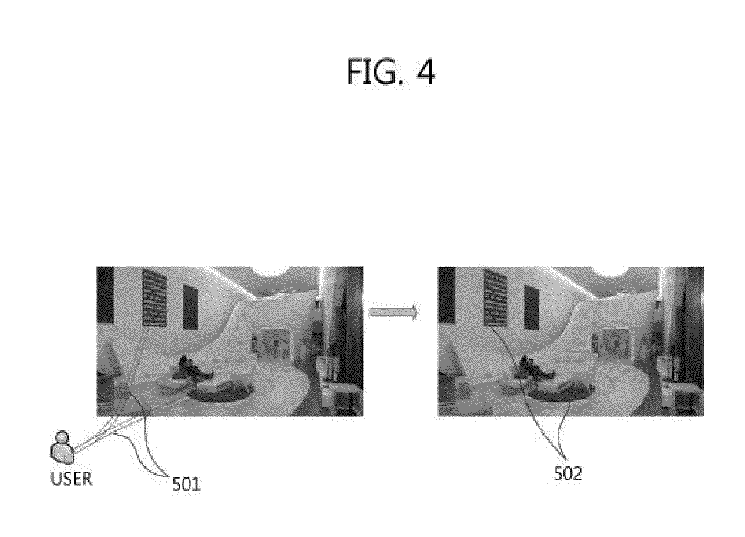

FIG. 4 is a diagram showing an example of highlighting an item by the additional information providing terminal unit 100, that is, a case in which a user is interested in a product appearing in a media content.

As shown in FIG. 4, when the user designates a specific item, for example, furniture or a decoration, using a touch screen, a remote controller, or the like, during viewing of the media content (501), the additional information providing terminal unit 100 may highlight the selected item in a preset highlighting scheme (502). For example, in the case in which it is set in the metadata of the media content that a portion of an edge of the item is highlighted by a specific color, the additional information providing terminal unit 100 may highlight a portion of the edge of the item by the specific color. In this case, the user may recognize that the additional information such as an advertisement, or the like, was inserted into the corresponding item.

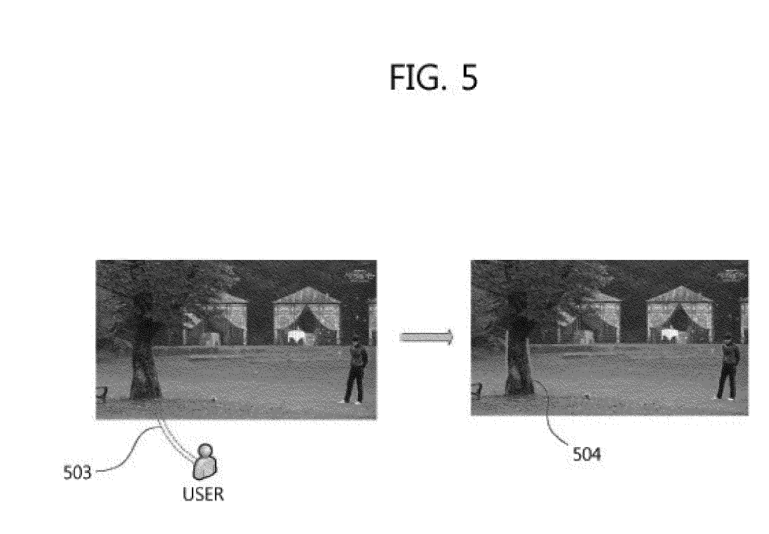

FIG. 5 is a diagram showing another example of highlighting an item by the additional information providing terminal unit 100, that is, a case in which a user is interested in a place at which a digital media content is photographed.

As shown in FIG. 5, when the user designates a specific topographic feature in a screen, for example, a landscape tree, a road, or the like, using a touch screen, a remote controller, or the like, during viewing of the media content (503), the additional information providing terminal unit 100 may highlight the selected topographic feature in a preset highlighting scheme (504). In this case, when the item is secondarily selected, information or an advertisement of the corresponding region is displayed.

Meanwhile, the additional information providing server unit 400 may generate the additional information on the item included in the media content and set information for realizing an additional information providing server by the additional information providing terminal unit 100, for example, a highlighting scheme of the item, or the like, insert the generated information into the metadata of the media content, and transmit the metadata to the additional information providing terminal unit, while interworking the broadcasting system 200 and the advertiser system 300. The additional information providing server unit 400 may insert information indicating that the additional information is linked to the item requested by the advertiser system in the media content into the metadata and designate a highlighting scheme of the metadata to insert the designated highlighting scheme into the metadata.

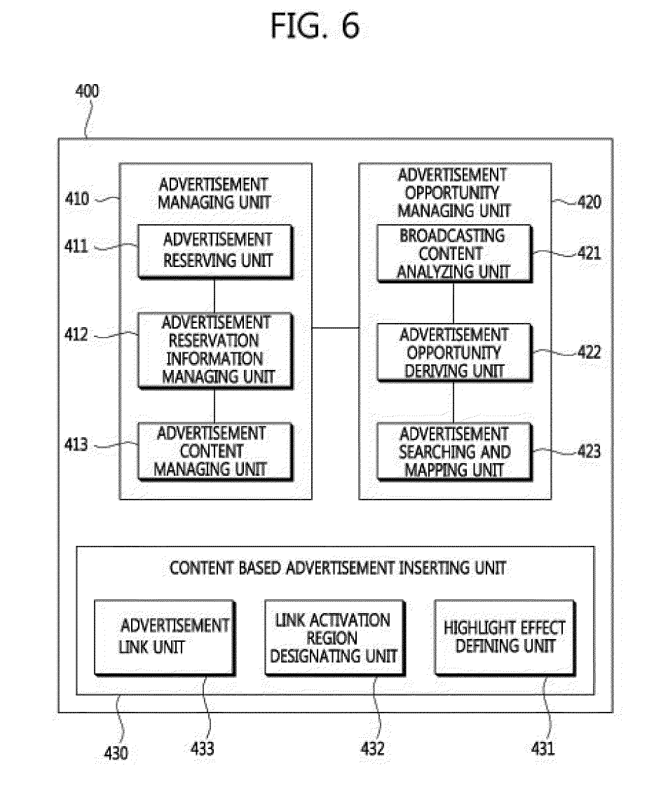

FIG. 6 is a block diagram describing a detailed configuration of an additional information providing server unit 400. The configuration of the additional information providing server unit 400 in the case in which additional information is an advertisement is shown in FIG. 6 by way of example. That is, FIG. 6 shows a case in which the additional information providing server unit 400 is implemented as an advertisement platform for providing the advertisement as the additional information. However, this is only an example and the additional information is not limited to the advertisement.

As shown in FIG. 6, the additional information providing server unit 400 may include an advertisement managing unit 410, an advertisement opportunity managing unit 420, and a content based advertisement inserting unit 430.

The additional information providing server unit 400 may receive an advertisement reservation from the advertiser system 300 to manage the advertisement reservation and analyze the broadcasting content to derive an advertisement opportunity to insert the advertisement requested by the advertisement by the advertiser system 300. In addition, the additional information providing server unit 400 may serve to connect the reserved advertisements to the derived advertisement opportunity, set a region that may be selected by the user so that the reserved advertisement are viewed only by an intentional selection of the user, that is an item region, and designate the region so as to be highlighted.

Here, a function of designating a portion or the entire of a specific item so as to be highlighted by the selection of the user may also be performed by the additional information providing terminal unit 100. In this structure, the function may be performed by using broadcasting content metadata and advertisement opportunity metadata manufactured in the additional information providing sever unit 400 and information described in the advertisement content metadata.

The advertisement managing unit 401 may receive an advertisement request from the advertiser system 300 to perform an advertisement reservation procedure. The advertiser system 300 may include a system of an advertiser or an advertising agent. The advertisement managing unit 401 may manage information required for executing the advertisement request by the advertiser system 300 and an advertisement content. In the management of the advertisement content, even files of an actual advertisement content may be stored and managed. In the case in which a separate content managing part is provided, metadata for corresponding advertisement contents may be received, stored, and managed to thereby be used to derive an advertisement opportunity.

An advertisement reserving unit 411 may serve to provide an user interface that may input information required for executing an advertisement, such as a program into which a corresponding advertisement is to be inserted, a viewer target group for which the corresponding advertisement is to be executed, a media company to which the corresponding advertisement is to be exposed, or the like, so that the advertiser system 300 may reserve an advertisement for a specific product on the premise that the advertisement is executed, thereby selling the advertisement.

An advertisement reservation information managing unit 412 may reconfigure, store, and manage information received from the advertiser system 300 through the advertisement reservation in a form required for organizing the advertisement.

An advertisement content managing unit 413 may manage an advertisement content registered through the advertiser system 300 reserving the advertisement and exposed at a point in time at which the corresponding advertisement is reproduced. The advertisement content managing unit 413 may also manage advertisement content metadata information on a corresponding advertisement content file.

In the case in which a separate advertisement content storing and managing unit is present outside the additional information providing server unit 400, an actual advertisement content may be managed by an external managing server, and the advertisement content managing unit 413 may receive and use a physical storing position at which the advertisement content file is stored and the metadata of the corresponding advertisement content. The advertisement content metadata may include information on a product and an advertisement included in the corresponding advertisement content and information related to manufacturing of the content.

The advertisement opportunity managing unit 420 may derive the advertisement opportunity from the advertisement content and manufacture metadata defining each advertisement opportunity, in order to provide a content based advertisement service.

An advertisement content analyzing unit 421 may serve to analyze the broadcasting content to search items into which additional information or an advertisement may be inserted, detect contents for a theme, a material, a background, a place, a participating character, used props, a sponsor participating in manufacturing corresponding broadcasting, a related product, or the like, and select additional information or a target into which the advertisement is to be inserted. That is, the advertisement content analyzing unit searches and describes which items may connect additional information or an advertisement to a corresponding broadcasting content.

The advertisement content analyzing unit 421 may derive the items using the broadcasting content metadata described at the time of manufacturing of the corresponding broadcasting content and the broadcasting content, generate identification information for each item, and add the generated identification information to the broadcasting content metadata.

An advertisement opportunity deriving unit 422 may acquire items expected for the advertisement to be inserted thereinto using the broadcasting content metadata generated in the broadcasting content analyzing unit 421. The advertisement opportunity deriving unit 422 may determine in which scene and at which position the related information or the advertisement is to be inserted into each item and describe features of corresponding items as the advertisement opportunity metadata.

In the case in which direct information on a material, a character, props, or the like, exposed in the broadcasting content is intended to be provided, the advertisement opportunity deriving unit 422 may describe a name, identification information, a manufacturing and selling company (that is, a subject of providing an advertisement and information) of a corresponding product, a scene in which the corresponding product is exposed, position information in the corresponding scene, or the like.

In the case in which information on a theme, a subject, a background, and a position included in the broadcasting content is intended to be provided, the advertisement opportunity deriving unit 422 may define features of the theme, the subject, the background, and the position. For example, the advertisement opportunity deriving unit 422 may describe features such as a trip (including detailed features such as a camping, a bicycle trip, a walking trip, a drive, or the like), an experience, a preferred age and group, a specific place name, a similar designation, and the like.

As described above, the described advertisement opportunity metadata may be used by an advertisement searching and mapping unit 423 determining which information file or advertisement content is to be connected to a corresponding advertisement opportunity.

The advertisement searching and mapping unit 423 may use the broadcasting content metadata, the advertisement opportunity metadata, and the advertisement content metadata described by the advertisement content analyzing unit 421, the advertisement opportunity deriving unit 422, the advertisement content managing unit 413, and the like. For example, the advertisement searching and mapping unit 423 may search an advertisement content matched to a feature of a specific item included in the broadcasting content.

In order to search the advertisement content, the advertisement searching and mapping unit 423 may use an advertisement content ID field present in the advertisement content metadata or an actual storing position field of the advertisement content. In the case in which the corresponding item is an advertisement for a specific product, the advertisement searching and mapping unit 423 may search an advertisement content for the corresponding product, and in the case in which the corresponding item is an advertisement having a theme, the advertisement searching and mapping unit 423 may select an advertisement content among advertisement contents having the same theme as their features. In this case, an applied selection reference may be based on the intention of advertisers or an advertisement organizing reference.

The content based advertisement inserting unit 430 may serve to insert a content based advertisement opportunity displayed or operated only by the selection of the user in order not to hinder immersion in the viewing when the user views the broadcasting content.

An advertisement link unit 431 serves to link a specific advertisement content to a specific position of a specific scene of a corresponding broadcasting content. In the case in which the corresponding broadcasting content is downloaded in a terminal in advance, only a corresponding file name may be linked, and in the case in which the corresponding file is downloaded and used from a place at which it is present at a point in time at which the advertisement is executed due to the absence of the corresponding file, position information of the corresponding place may also be linked.

A link activation region designating unit 432 may serve to designate a portion to be highlighted in a screen when a corresponding link is clicked. The link activation region designating unit 432 may designate the entirety of the corresponding item so as to be highlighted in the case in which the item has a small size and designate the entirety or a portion of the contour line in the case in which the item has an area of a set reference or more.

Further, in the case in which the item into which the additional information or the advertisement is to be inserted is not a specific product or item, but is a theme, a material, a background, a place, trip information of the broadcasting content, related information to may be configured to be inserted into a partial surface of a structure or a background screen in a screen. In this case, a shadow portion of the structure is used or related link information is inserted into a road, the sky, a wall surface of a building, a predetermined space in a landscape, a landscape tree, the water surface of the river and the lake, or the like, thereby making it possible to allow the corresponding information to be exposed by the selection of the user.

A highlight effect defining unit 433 may serve to designate a highlight effect so that a portion designated by the link activation region designating unit 432 is highlighted and exposed in the case in which the secondary selection of the viewer is conducted.

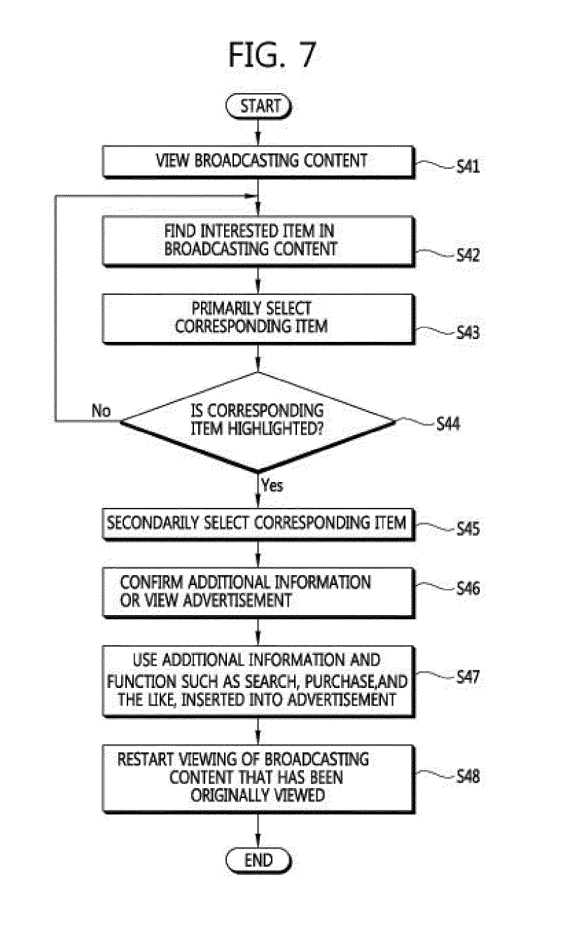

FIG. 7 is a flow chart describing a procedure of using a service in a system environment to which the method for providing additional information according to the exemplary embodiment of the present invention is applied. In FIG. 7, a procedure of using a service in a digital broadcasting environment is shown by way of example.

As shown in FIG. 7, the user may view the broadcasting content in various types of digital broadcasting environments, for example, through a terrestrial TV, a CATV, an IPTV, a smart TV, a DMB, and the like.

During the viewing of the broadcasting content, the user may find an interested item in the broadcasting content (S42). For example, the user may be interested in all items included in the content, such as additional information related to a theme, a material, a background, a place, trip information, an actor, a manufacturer, or the like, of the broadcasting content, product information on props worn by actors, and the like.

In this case, the user may primarily select (that is, a first selection) a corresponding item using an intention expressing unit that may be used in a corresponding service environment, for example, a touch screen, a remote controller, or the like, in order to obtain the additional information such as the advertisement, or the like, on the interested item (S43). This first selection may be performed in order to confirm whether the additional information on the corresponding item is present.

In this case, the additional information providing terminal unit 100 judges whether the additional information linked to the item is present and highlights the item designated by the user in response to the user selection in the case in which the additional information is linked to the item designated by the user. The user may judge whether or not the additional information is present according to whether or not the designated item is highlighted (S44). In this operation, the user may also repeatedly perform the first selection for the items in order to check whether or not the additional information is linked to other items in the screen.

The user may secondarily select (that is, a second selection) the item highlighted after the first section (S45). When the secondary selection is performed, the linked additional information may be exposed on the screen in a state in which the reproduction of the broadcasting content that is currently being reproduced is paused (S46).

The user may use additional information and functions additionally provided from the additional information, such as search, purchase, or connection to a detailed information site through a web page, or the like, through the newly exposed additional information (S47). When the viewing of the additional information and a manipulating procedure through it are completed, the user may continuously view the broadcasting content reproduced from a scene that he/she has originally viewed immediately before he/she views the additional information (S48).

As set forth above, according to the present invention, when the item displayed at the time of the reproduction of the media content is primarily selected, the selected item may be highlighted, and when the item is secondarily selected, the additional information linked to the item may be displayed. Therefore, it is possible to efficiently display the additional information linked to the media content without hindering the viewing of the media content as much as possible.

Hereinabove, although the present invention have been described with reference to the exemplary embodiments thereof, those skilled in the art will appreciate that various modifications, additions and substitutions are possible, without departing from the scope and spirit of the invention as disclosed in the accompanying claims. Therefore, modifications of the exemplary embodiments of the present invention will not depart the scope of the present invention.

What is claimed is:

1. A method for providing additional information using an apparatus for providing additional information included in a user terminal, the method comprising:
detecting an item selected by a user selection when the user selection is sensed in a media content that is being reproduced;
judging whether the user selection is a first selection for primarily selecting the item or a second selection for secondarily selecting the item in a set time after the item is primarily selected; and
highlighting at least a portion of the item according to a set display format according to whether or not additional information linked to the item is present in the case in which the user selection is the first selection and displaying the additional information linked to the item in the case in which the user selection is the second selection.

2. The method of claim 1, further comprising:
pausing the media content that is being reproduced based on the sensing of the user selection; and
reproducing the paused media content from a point in time at which the media content is paused in the case in which the second selection is not sensed for the set time after the first selection or the displaying of the additional information linked to the item ends.

3. The method of claim 1, wherein the additional information is an advertisement linked to the item and includes information for reproducing an advertisement content or moving to a linked web page.

4. The method of claim 1, wherein the highlighting of at least a portion of the item according to the set display format includes highlighting any one of at least a portion of an edge portion of the item or the entire item.

5. The method of claim 1, wherein the displaying includes:
judging whether the additional information linked to the item is present based on metadata of the media content in the case in which the user selection is the first selection; and
highlighting at least a portion of the item in the case in which the additional information linked to the item is present.

6. An apparatus for providing additional information included in a user terminal, the apparatus comprising:
a selection item detecting unit detecting an item selected by a user selection when the user selection is sensed in a media content that is being reproduced;
a selection judging unit judging whether the user selection is a first selection for primarily selecting the item or a second selection for secondarily selecting the item in a set time after the item is primarily selected; and
an information displaying unit highlighting at least a portion of the item according to a set display format according to whether or not additional information linked to the item is present in the case in which the user selection is the first selection and displaying the additional information linked to the item in the case in which the user selection is the second selection.

7. The apparatus of claim 6, wherein the information displaying unit pauses the media content that is being reproduced based on the sensing of the user selection and reproduces the paused media content from a point in time at which the media content is paused in the case in which the second selection is not sensed for the set time after the first selection or the displaying of the additional information linked to the item ends.

8. The apparatus of claim 6, wherein the additional information is an advertisement linked to the item and includes information for reproducing an advertisement content or moving to a linked web page.

9. The apparatus of claim 6, wherein the information displaying unit highlights any one of at least a portion of an edge portion of the item or the entire item.

10. The apparatus of claim 6, wherein the information displaying unit judges whether the additional information linked to the item is present based on metadata of the media content in the case in which the user selection is the first selection and highlights at least a portion of the item in the case in which the additional information linked to the item is present.

11. A method for providing additional information, the method comprising:
judging whether or not additional information linked to an item displayed in a media content that is being reproduced is present based on metadata of the media content in response to a first selection for primarily selecting the item;
highlighting at least a portion of the item according to a set display format according to whether or not the additional information linked to the item is present; and
displaying the additional information linked to the item in response to a second selection for secondarily selecting the item.

12. The method of claim 11, further comprising:
pausing the media content that is being reproduced in the case in which the additional information linked to the item is present; and
reproducing the paused media content from a point in time at which the media content is paused in the case in which the displaying of the additional information linked to the item ends.

13. The method of claim 11, wherein the highlighting includes highlighting any one of at least a portion of an edge portion of the item or the entire item.

14. A system for providing additional information, the system comprising:
a server unit inserting additional information linked to an item included in a media content and a highlighting scheme to be applied to the item into metadata of the media content and transmitting the metadata; and
a terminal unit judging whether or not the additional information linked to the item is present based on the metadata received from the server unit in response to a first selection of a user for primarily selecting the item at the time of reproduction of the media content, highlighting at least a portion of the item according to a set display format according to whether or not the additional information linked to the item is present, and displaying the additional information linked to the item in response to a second selection of the user for secondarily selecting the item.

15. The system of claim 14, wherein the terminal unit pauses the media content that is being reproduced in the case in which the additional information linked to the item is present and reproduces the paused media content from a point in time at which the media content is paused in the case in which the displaying of the additional information linked to the item ends.

16. The system of claim 14, wherein the terminal unit highlights any one of at least a portion of an edge portion of the item or the entire item.

17. The system of claim 14, wherein the server unit interworks with an advertiser system, inserts information indicating that the additional information is linked to the item requested by the advertiser system in the media content into the metadata, and designates the highlighting scheme of the metadata to insert the designated highlighting scheme into the metadata.
